(19) United States
(12) Patent Application Publication
(10) Pub. No.: US 2003/0120667 A1
(43) Pub. Date: Jun. 26, 2003

(54) Apparatus for processing method-embedded content and method thereof

(76) Inventors: Yeon Jeong Jeong, Taejon (KR); Do Won Nam, Taejon (KR); Ki Song Yoon, Taejon (KR); Jun Suk Lee, Taejon (KR); Seong Un Hwang, Taejon (KR); Jung Hyun Kim, Gwangju (KR); Myung Joon Kim, Taejon (KR)

Correspondence Address: JACOBSON, PRICE, HOLMAN & STERN, PROFESSIONAL LIMITED LIABILITY COMPANY, 400 Seventh Street. N.W., Washington, DC, 20004, US

(21) Appl. No.: 10/190,672

(22) Filed: Jul. 9, 2002

(30) Foreign Application Priority Data
Dec. 20, 2001 (KR) 2001 - 81718

(51) Int. Cl. G06F 7/00

(52) U.S. Cl. 707/100

(57) ABSTRACT

Disclosed are an apparatus for processing a method-embedded content and a method thereof. The apparatus includes a content packager for packaging a content, metadata, and method, a content unpackager for separating the content, metadata, and method from the packaged content, a method manager section for managing the method extracted from the package, a method execution environment section for securing a safe execution of the method by constructing an environment independent of other parts of a system, an access control section for controlling an access of the method for the content and metadata only in an authenticated software module, an authentication management section for authenticating the software module that intends to access the content, and a content player for processing the method-embedded content. The apparatus provides the content objective environment that can support diverse content applications desired by a user, and maximizes the content applications. Also, the apparatus enables the user to easily develop additional functions for the content playback, and the convenience in use can be increased through implementation of the content player having functions to meet the users'taste by sharing the additional functions with other users.

### BACKGROUND OF THE INVENTION

1. Field of the Invention

The present invention relates to a content processing apparatus for processing a content provided through various kinds of wire/wireless communication networks such as the Internet or PC communication networks, and more particularly, to an apparatus for processing a method-embedded content and a method thereof.

2. Background of the Related Art

Generally, various kinds of contents such as a text, image, audio, video, etc., provided through various kinds of wire/wireless communication networks such as the Internet or PC communication networks are played by a content player such as a Microsoft windows media player, real player, macromedia flash, etc., and in order to play such contents, it is necessary to install a player software in a PC of a user.

However, since the content processing technique using the conventional content players as described above has the drawback in that the user should install a proper content player, the content cannot be immediately played when the user gets the content.

Also, since the function of the content player is limited so that the content can be used through the function provided in the content player only, there is no means for representing the content with accommodation of diverse types desired by a content producer, and indicating the characteristic of the content.

Consequently, though the use of the digital contents has been popularized and the demand for the content application has been increasing, the conventional content processing technique cannot fulfill the diverse needs as described above.

### SUMMARY OF THE INVENTION

Accordingly, the present invention is directed to an apparatus for processing a method-embedded content and a method thereof that substantially obviate one or more problems due to limitations and disadvantages of the related art.

It is an object of the present invention to provide an apparatus for processing a method-embedded content and a method thereof that can effectively represent the contents and characteristic of the content by combining a method that can support the characteristic and application of each content and metadata that includes a description of the content, right of use, rule of use, etc., with the conventional content.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided an apparatus for processing a method-embedded content comprising a content packager for packaging and encoding a content, metadata, and method, and attaching an electronic signature thereto if needed; a content unpackager for separating the content, metadata, and method from the packaged content, respectively, checking the electronic signature if it is attached to the content, metadata, and method, and decoding the content, metadata, and method if they are encoded; a method manager section for checking if the method is a normal code, and managing the method extracted from a package; a method execution environment section for securing a safe execution of the method by constructing an environment independent of other parts of a system; an access control section for reading and analyzing the metadata, judging whether a software that accesses the metadata is authenticated if needed, and controlling an access of the method for the content and metadata only in an authenticated software module; an authentication management section for managing to authenticate the software module that intends to access the content if the authentication is needed; and a content player for providing an access application program interface (API) with respect to the content, metadata, and method, managing authentication information of the software, and processing the method-embedded content by requesting the execution of the method and receiving a result of the method execution.

In another aspect of the present invention, there is provided a method of processing a method-embedded content comprising the steps of a content producer encoding, attaching an electronic signature to, and packaging a content, metadata, and method using a packaging software if needed; a user attempting a playback of the packaged content by driving a playback software; if an authentication of the software is needed, authenticating whether the playback software is an approved software that can access the packaged content; the authenticated software requesting an access of the content and metadata in the package or an execution of the method in the package; a content unpackager separating the content, metadata, and method from the package; determining whether to permit the access request of the software through an analysis of the metadata; transmitting the content and metadata to the authenticated software; if a method manager section determines whether to execute the method separated by the content unpackager by checking the method, a method execution environment section executing the method, and transferring a result of execution to a playback software of a content player; and the content player playing the content based on the transferred result of execution of the content, metadata, and method.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of a method-embedded content processing apparatus according to the present invention.

FIG. 2 is a block diagram of a content packager in FIG. 1.

FIG. 3 is a block diagram of a content unpackager in FIG. 1.

FIG. 4 is a block diagram of a method manager section in FIG. 1.

FIG. 5 is a block diagram of a method execution environment section in FIG. 1.

FIG. 6 is a block diagram of an access control section in FIG. 1.

FIG. 7 is a block diagram of an authentication management section in FIG. 1.

FIG. 8 is a block diagram of a content player in FIG. 1.

FIG. 9 is a flowchart illustrating a method-embedded content processing method according to the present invention.

FIG. 10 is a block diagram of the content player of the method-embedded content processing apparatus in a playback state of the method-embedded content according to the present invention.

### DETAILED DESCRIPTION OF THE PREFERRED EMBODIMENT

The method-embedded content processing apparatus according to the preferred embodiment of the present invention will now be explained in detail with reference to the accompanying drawings.

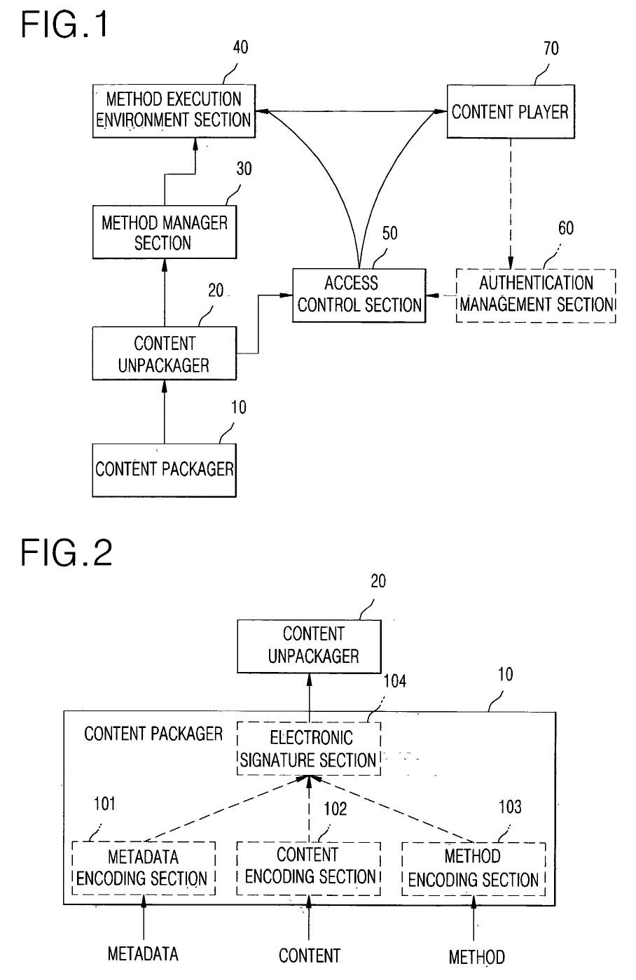

Referring to FIG. 1, a content packager 10 packages a content, metadata, and method, and if needed, it encodes and attaches an electronic signature to them.

Referring to FIG. 2, a metadata encoding section 101 of the content packager 10 encodes the metadata information if needed.

A content encoding section 102 encodes the content.

A method encoding section 103 encodes the method provided from a producer.

An electronic signature section 104 attaches an electronic signature if needed to check any forgery/alteration of the metadata, content, and method.

A content unpackager 20 separates the content, metadata, and method from the packaged content, checks the electronic signature if it is attached to the content, metadata, and method, and decodes the content, metadata, and method if they are encoded.

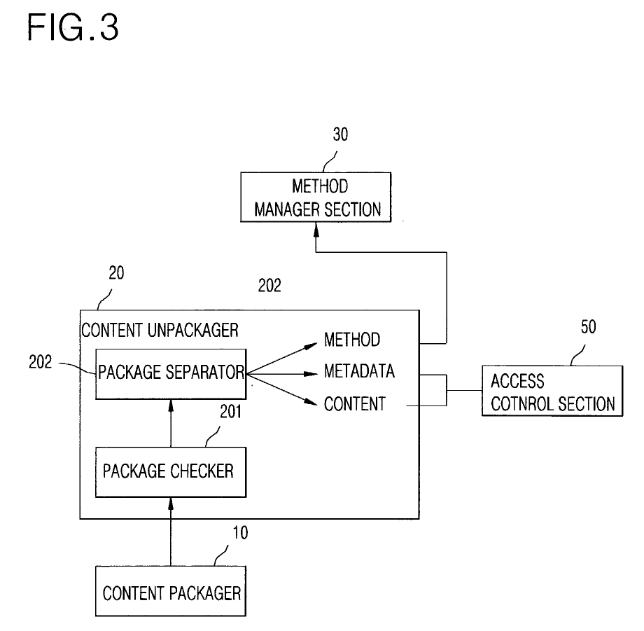

Referring to FIG. 3, a package checker 201 of the content unpackager 20 confirms if the elements in the package are forged/altered by checking the electronic signature if it is attached to the elements in the package.

A package separator 202 decodes the metadata, content, and method if they are encoded, and separates them from the package.

A method manager section 30 checks if the method is a normal code, and manages the method extracted from the package.

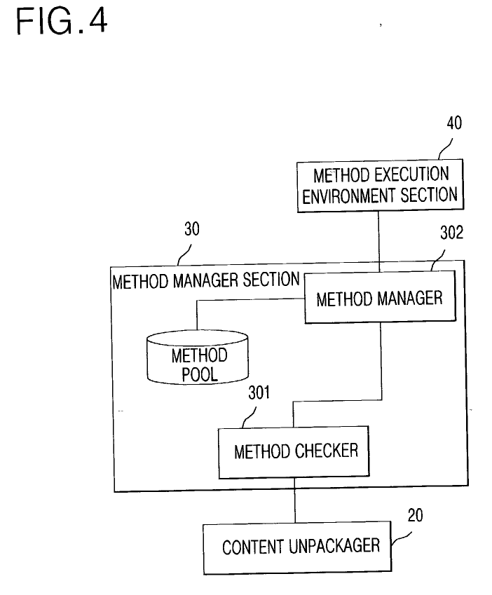

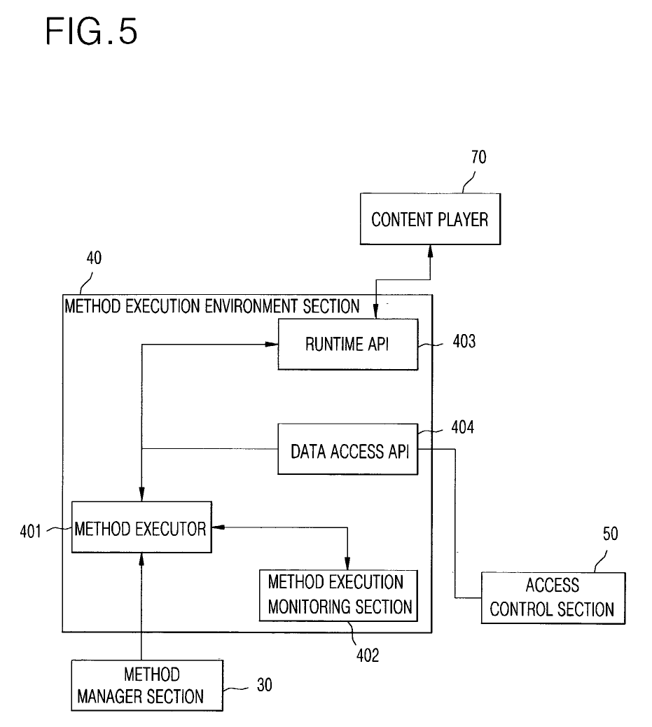

Referring to FIG. 4, a method checker 301 of the method manager section 30 checks if the method is a normal code.

A method manager 302 manages the methods separated from the package.

A method execution environment section 40 secures a safe execution of the method by constructing an environment independent of other parts of a system.

The method execution environment section 40 receives a request for method execution from a content player 70, performs the method, and returns a result of the method execution to the content player 70. The method execution environment section 40 also provides a data access required during the method execution, and monitors the method being executed.

Referring to FIG. 5, a method executor 410 of the method execution environment section 40 executes the method.

A method execution monitoring section 402 monitors the method being executed so that the method being executed does not exert a bad influence upon the system.

A runtime application program interface (API) 403 serves to receive the request for method execution from the content player 70 and then to turn over a result of the method execution to the content player 70.

A data access API 404 takes charge of the access of the metadata required for executing the method and the content.

An access control section 50 reads and analyzes the metadata, judges whether the software that accesses the metadata is authenticated if needed, and controls the access of the method for the content and metadata only in an authenticated software module.

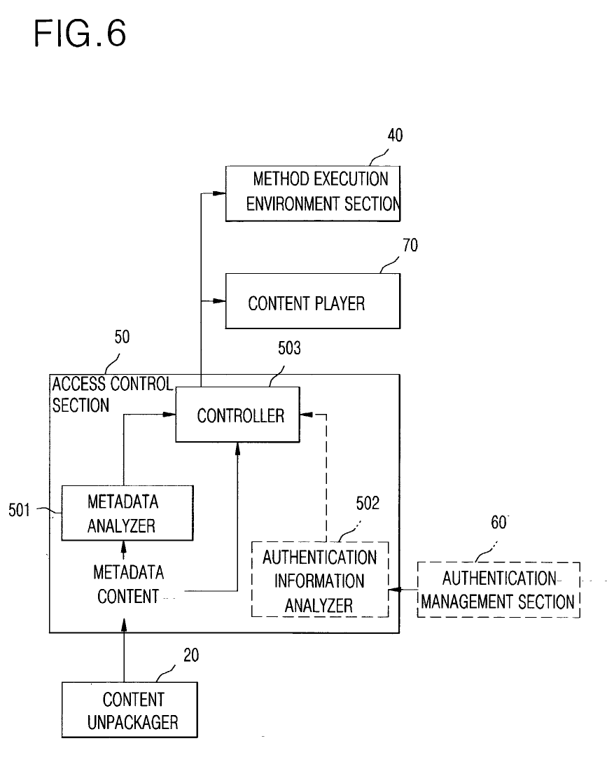

Referring to FIG. 6, a metadata analyzer 501 of the access control section 50 reads and analyzes the metadata.

An authentication information analyzer 502 checks if the authenticated software module intends to access the data and informs a result of checking when authenticating the software.

A controller 503 controls the software's access of the method for the content and metadata based on a result of analyzing the authentication information and metadata.

An authentication management section 60 manages to authenticate the software module that intends to access the content if the authentication is needed.

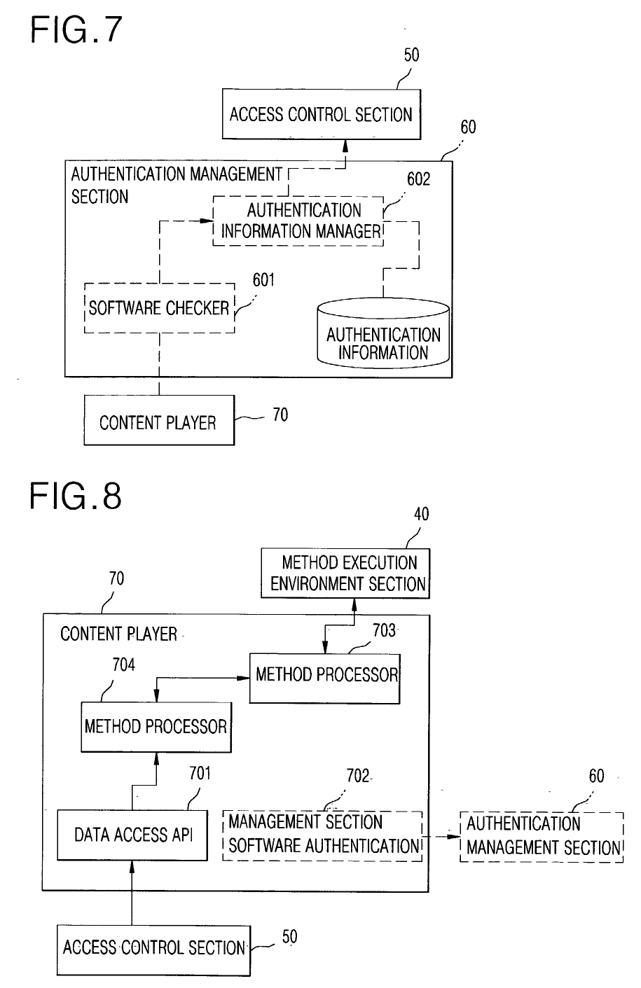

Referring to FIG. 7, a software checker 601 of the authentication management section 60 operates only when the authentication of the software is needed, and confirms the authentication information of the software.

An authentication information manager section 602 stores and manages the authentication information.

The content player 70 provides an access API with respect to the content, metadata, and method, manages the authentication information of the software, and processes the method-embedded content by requesting the execution of the method and receiving a result of the method execution.

Referring to FIG. 8, a data access API 701 of the content player 70 requests the access of the content and metadata, and receives the corresponding data.

A software authentication management section 702 manages and provides the authentication information of the software if the authentication is needed.

A method processor 703 requests the execution of the method, and receives a result of execution.

A content playback section 704 actually deals with the content.

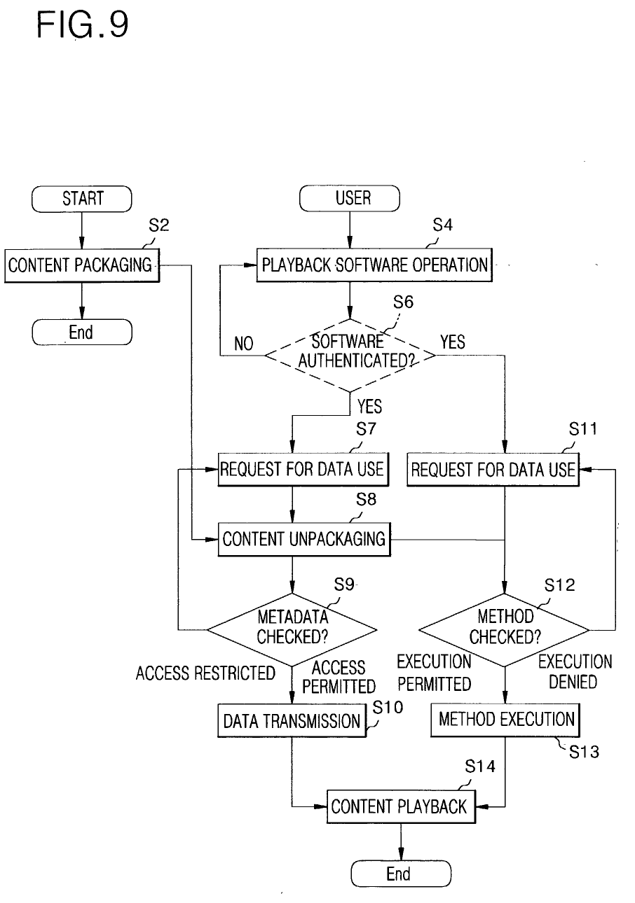

The method-embedded content processing apparatus as constructed above according to the present invention operates in accordance with a method illustrated in FIG. 9.

Referring to FIG. 9, a content producer packages the content to be packaged using a packaging software, method required for its application, and metadata through the content packager 10, and if needed, it performs an encoding process and an electronic signature process (step S2).

Meanwhile, a user operates the content player 70, and a playback software of the content player 70 driven thereby attempts a playback of the packaged content (step S4).

At this time, if the authentication of the software is needed, the authentication management section 60 authenticates whether the playback software is an approved software that can access the packaged content (step S6). Then, the authenticated software requests the access of the content and metadata in the package through the access control section 50 (step S7), and requests the execution of the method in the package (step S11).

The package transferred from the producer to the user is separated into the content, metadata, and method after its signature is checked through the content unpackager 20, and then the separated content, metadata, and method are decoded (step S8). Then, if it is determined whether to permit the access request of the playback software by confirming whether the access of the data requested by the playback software is proper through the access control section 50 (step S9), the content and metadata are transferred to the content player 70 (step S10).

The method separated by the content unpackager 20 (step S8) is checked through the method manager section 30, and its execution is determined (step S12). The execution of the method is performed through the method execution environment section 40 constructed not to affect other parts of the system (step S13).

The request for execution of the method or the result of execution is transferred to the playback software of the content player 70 through the runtime API 403 of the method execution environment section 40, and the content is actually played through the content player 70 based on the transferred result of execution of the content, metadata, and method (step S14).

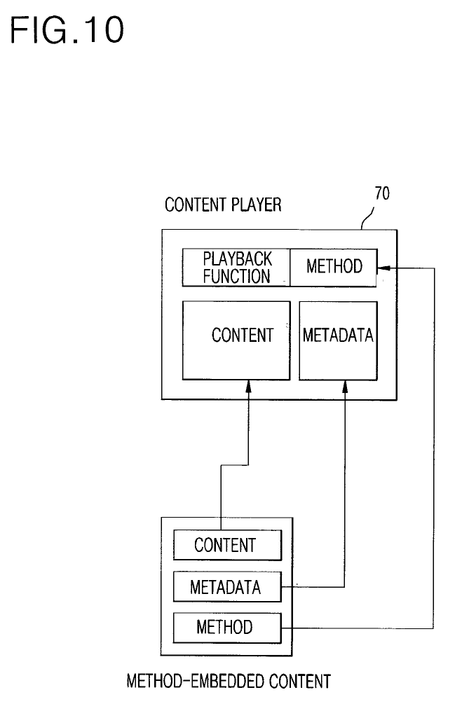

Referring to FIG. 10, it can be known that the content player 70 not only plays the content in the same manner as the conventional content player but also processes the content using the content, metadata, and method.

As described above, since the method-embedded content processing apparatus and method according to the present invention can effectively represent the contents and characteristic of the content by combining a method that can support the characteristic and application of each content and metadata that includes a description of the content, right of use, rule of use, etc., with the conventional content, the content objective environment that can support diverse content applications desired by a user can be provided, and the content applications can be maximized. Also, it enables the user to easily develop additional functions for the content playback, and the convenience in use can be increased through implementation of the content player having functions to meet the users' taste by sharing the additional functions with other users.

While the method-embedded content processing method according to the present invention has been described illustrated herein with reference to the preferred embodiment therof, it will be understood by those skilled in the art that various changes and modifications may be made to the invention without departing from the spirit and scope of the invention, which is defined in the appended claims.

What is claimed is:

1. An apparatus for processing a method-embedded content comprising:
a content packager for packaging and encoding a content, metadata, and method, and attaching an electronic signature thereto if needed;
a content unpackager for separating the content, metadata, and method from the packaged content, respectively, checking the electronic signature if it is attached to the content, metadata, and method, and decoding the content, metadata, and method if they are encoded;
a method manager section for checking if the method is a normal code, and managing the method extracted from a package;
a method execution environment section for securing a safe execution of the method by constructing an environment independent of other parts of a system;
an access control section for reading and analyzing the metadata, judging whether a software that accesses the metadata is authenticated if needed, and controlling an access of the method for the content and metadata only in an authenticated software module;
an authentication management section for managing to authenticate the software module that intends to access the content if the authentication is needed; and
a content player for providing an access application program interface (API) with respect to the content, metadata, and method, managing authentication information of the software, and processing the method-embedded content by requesting the execution of the method and receiving a result of the method execution.

2. The apparatus as claimed in claim 1, wherein the content packager comprises:
a metadata encoding section for encoding the metadata information if the encoding is needed;
a content encoding section for encoding the content;
a method encoding section for encoding the method provided from a producer; and
an electronic signature section for attaching an electronic signature to check any forgery/alteration of the metadata, content, and method if the electronic signature is needed.

3. The apparatus as claimed in claim 1, wherein the content unpackager comprises:
a package checker for confirming that elements in the package are not forged/altered by checking the electronic signature if the electronic signature is attached to the elements; and
a package separator for decoding the metadata, content, and method if they are encoded, and separating the elements from the package.

4. The apparatus as claimed in claim 1, wherein the method manager section comprises:
a method checker for checking if the method is a normal code; and
a method manager for managing the methods separated from the package.

5. The apparatus as claimed in claim 1, wherein the method execution environment section comprises:
a method executor for executing the method;
a method execution monitoring section for monitoring the method being executed so that the method being executed does not exert a bad influence upon the system;
a runtime application program interface (API) for serving to receive the request for method execution from the content player, and to transfer a result of the method execution to the content player; and
a data access API for taking charge of the access of the metadata required for executing the method and content.

6. The apparatus as claimed in claim 1, wherein the access control section comprises:
a metadata analyzer for reading and analyzing the metadata;
an authentication information analyzer for checking if the authenticated software module intends to access the data, and informing a result of checking when the authentication of the software is needed; and
a controller for controlling the software's access of the method for the content and metadata based on a result of analyzing the authentication information and metadata.

7. The apparatus as claimed in claim 1, wherein the authentication management section comprises:
a software checker for confirming the authentication of the software if needed; and
an authentication information manager section for storing and managing the authentication information.

8. The apparatus as claimed in claim 1, wherein the content player comprises:
a data access API for requesting the access of the content and metadata, and receiving the corresponding data;
a software authentication management section for managing and providing the authentication information of the software if the authentication of the software is needed;
a method processor for requesting the execution of the method, and receiving a result of execution; and
a content playback section for actually dealing with the content.

9. A method of processing a method-embedded content comprising the steps of:
a content producer encoding a content, metadata, and method, attaching an electronic signature, and packaging the content, metadata, and method using a packaging software if needed;
a user attempting a playback of the packaged content by driving a playback software;
if an authentication of the software is needed, authenticating whether the playback software is an approved software that can access the packaged content;
the authenticated software requesting an access of the content and metadata in the package or an execution of the method in the package;
a content unpackager separating the content, metadata, and method from the package;
determining whether to permit the access request of the software through an analysis of the metadata;
transmitting the content and metadata to the authenticated software;
if a method manager section determines whether to execute the method separated by the content unpackager by checking the method, a method execution environment section executing the method, and transferring a result of execution to a playback software of a content player; and
the content player playing the content based on the transferred result of execution of the content, metadata, and method.
